(19) United States
(12) Patent Application Publication
(10) Pub. No.: US 2004/0226047 A1
(43) Pub. Date: Nov. 11, 2004

(54) Live broadcasting method and its system for SNG webcasting studio

(76) Inventors: Jyh-Bor Lin, Taipei (TW); Jeff Chai, Taipei (TW); Liang-Yi Lai, Jung-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/428,822

(22) Filed: May 5, 2003

(51) Int. Cl. H04N 7/173; H04N 7/16; G06F 15/16

(52) U.S. Cl. 725/109; 725/112; 725/148; 709/217

(57) ABSTRACT

A live broadcasting method and its system for SNG webcasting studio is an easy tool for producing teaching material and online live broadcasting. The system comprises SNG audio/video special effect equipment, a webeasting encoder, a synchronization control program for streaming audio/video, presentation files and digital whiteboard and a streaming server. Through the SNG webcasting studio, multimedia content is easily integrated. Teaching material is produced immediately and output for online broadcasting. Further, the system allows the integration of the broadcasted content from camcorder or VCR and PowerPoint files. Through Intranet or Internet, the teaching or training program is broadcasted online. The viewer only needs to logon Internet to watch the teaching or training program.

### BACKGROUND OF THE INVENTION

1. Field of the Invention

The present invention is related to a live broadcasting method and its system for SNG webcasting studio. The system is composed of SNG (Satellite News Gathering) equipment for audio/video special effect, a webcasting encoder, a synchronization control program for streaming audio/video, presentation files and digital whiteboard and a media server. The system can integrate image, voice and presentation. The system also allows real-time or non-real-time broadcasting on web. The live broadcasting method and its system for webcasting studio focus on simple operation and convenient portability.

2. Description of the Prior Art

As a tradition for Chinese learning habit, students would avoid asking questions for the fear of being laughed at or complained by other students. In the past, distance learning was only based on one-way transmission. Students could merely watch the films without interaction with the instructor. The motivation for learning would gradually decrease. Further due to lack of self-assessment as in a group-learning environment, the learning achievement is poor. On the other hand, when live broadcasting is conducted for real-time teaching, training or meeting, the user needs related experiences on the web and knowledge on computer networking or infrastructure. Moreover, the user needs expertise in digital media production or audio/video special effect. However, usually it takes a great deal of time and workforce to produce such a program. It is not very economical.

In view of this, the traditional equipment still has many disadvantages and needs to be improved. The inventor for the present invention was seeking improvement and after many years of dedication in R&D finally successfully developed the live broadcasting method and its system for SNG webcasting studio.

### SUMMARY OF THE INVENTION

The objective of the present invention is to provide a live broadcasting method and its system for SNG webcasting studio that allows real-time broadcasting for online teaching or training program. After broadcasting, the system will automatically transform the live program into a video file, Video On Demand. The system will also automatically put the file with teaching or training program in designated website available for the viewer to select.

Another objective of the present invention is to provide a live broadcasting method and its system for SNG webcasting studio that focuses main design on easy operation and convenient portability. The user does not need to learn Internet, website setup and FTP, but only fills in several columns and presses few buttons to achieve the distance learning or training purpose through Internet.

Another objective for the present invention is to provide a live broadcasting method and its system for SNG webcasting studio that allows the user to achieve Internet online teaching or training purpose any time by combining training teaching facilities such as camcorder, computer and VCR.

Another objective for the present invention is to provide a live broadcasting method and its system for SNG webcasting studio that has the main function with the traditional TV studio. Through the buttons and control sticks for the special effect equipment, the system enables scene transitions and special effects as in TV studio and the instant output of digital signal.

Another objective for the present invention is to provide a live broadcasting method and its system for SNG webcasting studio that helps user integrate current camcorder, PC and Internet system equipment to achieve distant learning, training, distant broadcasting, conference or seminar without being limited by environmental condition.

The steps to attain the objective for the present invention for the live broadcasting method for SNG webcasting studio are as follows:

Step 1: The audio/video input device for the SNG special effect equipment receives audio/video signals.

Step 2: The audio/video signals received by the special effect equipment are processed and integrated to become data files through video receiving device, audio receiving device and digital special effect.

Step 3: The SNG special effect equipment transmits the completed data files to Internet broadcasting encoder through output device.

Step 4: The Internet broadcasting encoder is a Media Producer software to process the received data files through a control program for an automated process.

Step 5: The control program for an automated process integrates the data files by a synchronization control program for streaming audio/video, presentation files and a digital whiteboard.

Step 6: The synchronization control program for the streaming audio/video, presentation files and the digital whiteboard uses PPT, Word, HTML or digital whiteboard to integrate data files.

Step 7: The control program for the automated process transform the completed data files into digital media files in WMV&WMA or MPEG4 format through compression program and transmit them to the streaming server.

Step 8: The audio/video server broadcasts live programs with the received data files to the receiving terminals.

Step 9: The streaming server first integrates the broadcasted data files with the Script command program and Marker program at user end during live broadcasting and notes on synchronization requirement, then saves the files and automatically transforms the files into VOD (Video On Demand) digital files.

Step 10: At receiving end, access to Internet is available for selecting files outputted from audio/video server.

The SNG webcasting studio to achieve the above objectives is composed of:

A SNG special effect equipment, which comprises multiple video input devices and audio input devices and is able to save the media files in VHS or VCD formats after mixing and special effect treatment, and is also able to transmit data file to webcasting encoder through USB interface or IEEE1394 specification.

A webcasting encoder, using Media Producer software and receiving the data files from the SNG special effect equipment, and transforming the digital media data files into WMV&WMA files or MPEG4 files through a compression process with an automated process control program. The automated process control program is to simplify the process for producing instructional program. A flow process is provided to assist the user in completing the production of the teaching program by combining synchronization control program for streaming audio/video, presentation files and digital whiteboard with application software for live program production, PPT, Word, HTML, digital whiteboard or monitor output device. Then, the files are compressed into WMV&WMA digital media format or MPEG4 format and transmitted to media server.

A synchronization control program for streaming audio/video, presentation files, and digital whiteboard, which under an automated process control program can combine PPT, WORD, HTML, or the output interfaces like digital whiteboard and computer monitor to complete file integration.

An streaming server, having a Web Server and a Media Server to provide real-time broadcasting and management on instructional program and digital files (Video On Demand, VOD). The web server is to note every command of the on-site user during broadcasting by using Script and Marker programs for WMV&WMA digital audio/video files and save the files after broadcasting is finished. The streaming server will transform the commands in real-time broadcasted files into outline hint window. When the online viewer selects files, the outline hint will display on course bulletin board and PPT outline hint window to help the viewer choose the desired section; among which the VOD (Video On Demand) digital files will be broadcasted at the same time. The on-site user's command and notes will be put down and automatically transformed into VOD (Video on Demand) digital files.

The live broadcasting method and its system for SNG webeasting studio uses a SNG audio/video special effect equipment to receive audio/video data and outputs/saves the data or transmits the data to webcasting encoder through video receiving device, audio receiving device and special effect treatment. The webcasting encoder is Media Producer software, comprising an automated process control program and an audio/video presentation and digital process control program. The automated process control program combines PPT, WORD, HTML, digital whiteboard or computer output interface through synchronization control program for streaming audio/video, presentation files and digital whiteboard to integrate data files by automatically transforming the data files into WMV&WMA digital media files, which are then transmitted to an streaming server that is composed of a Web Server and a Media Server. The streaming server receives the data files from webcasting encoder for online live broadcasting and automatically transforms the files into VOD digital files that is available for selection by the online viewer.

### BRIEF DESCRIPTION OF THE DRAWINGS

The drawings disclose an illustrative embodiment of the present invention, which serves to exemplify the various advantages and objects hereof, and are as follows.

Please refer to the following detailed description for a preferred embodiment and the attached figures for further understanding the technical content and objectives for the present invention. The attached figures are:

FIG. 1 is the configuration for the live broadcasting method and its system for SNG webcasting studio in the present invention.

FIG. 2 is an illustration for live broadcasting on the display at the receiving terminal for the live broadcasting method and its system for SNG webcasting studio.

### DETAILED DESCRIPTION OF THE PREFERRED EMBODIMENT

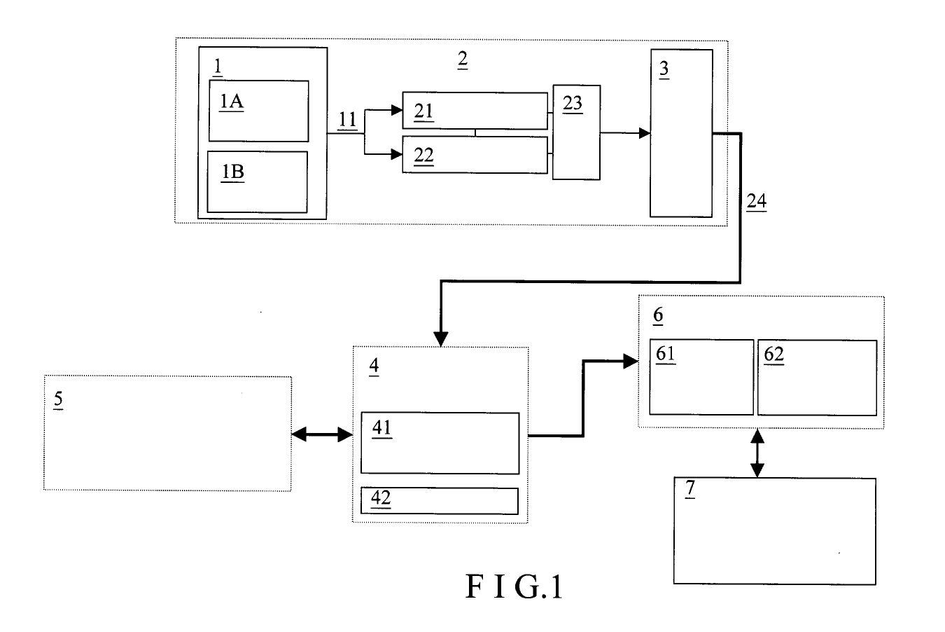

Please refer to FIG. 1. The live broadcasting method and its system for SNG webcasting studio is mainly composed of:

A SNG audio/video special effect equipment 2, comprising an audio/video input device 1, a video receiving device mechanism 21 and an audio receiving mechanism 22. The SNG audio/video special effect equipment 2 receives the image and voice from the audio/video input device 1. The audio/video input device 1 comprises a video input device 1A and an audio input device 1B. The video input terminal 11 for the audio/video input device 1 can be Composite terminal, S terminal, IEEE1394 specification device or wireless transmission and receive audio and video signals from camcorder, projector, VCR, VCD player, DVD player, CD player or microscope. After the treatment by SNG audio/video special effect equipment 2, the image and voice signals are added with digital special effect 23 to obtain the special effect and then are output to output device 3 through output interface 24 and then are saved in files. The output device 3 can be Composite terminal for saving in videotape or USB interface or IEEE1394 specification device for saving in files or backup in CD.

A webcasting encoder 4 is a Media Producer software, comprising an automated process control program 41 and a synchronization control program 5 for streaming audio/video, presentation files and digital whiteboard. The webcasting encoder 4 receives the media data from the SNG audio/video special effect equipment, and then automatically transforms the digital media data into WMV&WMA digital media files 42 or MPEG 4 through an automated process control program 41. The automated process control program is to simplify the process for producing teaching program. A flow process is provided to assist the user in completing the production of the teaching program by combining synchronization control program for a streaming audio/video, presentation files and digital whiteboard with application software for live program production, PPT, Word, HTML, digital whiteboard or monitor output device. Afterward, the files are transformed into WMV&WMA digital media files 42 or MPEG 4 and transmitted to audio/video server 6.

A synchronization control program for an audio/video presentation and digital whiteboard is composed of a PowerPoint Application, a digital whiteboard application and a monitor output interface. Under the process of the automated process control program 41, the software can combine PPT, WORD, HTML or digital whiteboard to complete data file integration.

A streaming server 6 is composed of a Web Server 61 and a Media Server 62. The web server 61 is to note every command of the on-site user during broadcasting by using Script and Marker programs of the webcasting encoder 4 for WMV&WMA digital audio/video files and save the files after broadcasting is finished. The Media Server 62 will transform the file commands into outline hint after broadcasting, so the outline hint will display on course bulletin board and PPT outline window for the online viewer to select the desired data files.

The goal is to support real-time broadcasting and VOD production for image, voice and text transmission. The learner will benefit from this in a teaching or training program. During live broadcasting, the data files, on-site operation commands and notes will be put down and saved as files after broadcasting, and finally automatically transformed to VOD digital files.

A viewer computer 7 uses browser program like IE or media playing program like Media Player to view the teaching or training program. Without additional program, real-time communication with broadcaster can be made through text interaction area.

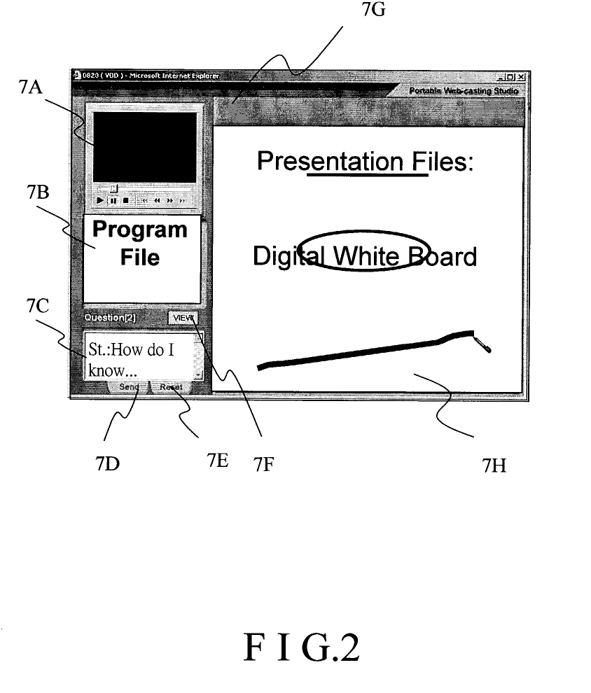

Please refer to FIG. 2. The viewer can receive the image and voice of the instructor through media playing program 7A. Playing, pause, fast forward and rewind are available. On course bulletin board and PPT outline hint window 7B, the viewer can select the outline and enter the section to view the film. The viewer can interact simultaneously with the instructor through the text interaction area 7C. The question is entered into the text interaction area 7C. Reset key 7E is to delete the entered data. Send key 7D is to send out the entered data. On the text interaction area 7C for the instructor, information will display immediately in real-time teaching program and allow replying instantly with answers. Message button 7F is to view the questions of his own or from other places and allow interaction with the instructor. Interface display BAR 7G is to display the user's organization name. PowerPoint Application output interface 7H is to display the instructor's presentation files, HTML files, PowerPoint files or WORD files, and allow the simultaneous display of voice, image, pictures and text on viewer end monitor.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A live broadcasting method for SNG webcasting studio, comprising the following steps:
Step 1: an audio/video input device for SNG special effect equipment receives audio/video signals;
Step 2: audio/video signals received by said special effect equipment are processed and integrated to become data files through video receiving device, audio receiving device and digital special effect;
Step 3: said SNG special effect equipment transmits completed data files to Internet broadcasting encoder through an output device;
Step 4: said Internet broadcasting encoder is Media Producer software to process said received data files through a control program for an automated process;
Step 5: said control program for an automated process integrates said data files by a synchronization control program for streaming audio/video, presentation files and a digital whiteboard;
Step 6: said synchronization control program for streaming audio/video, presentation files and said digital whiteboard uses PPT, Word, HTML or digital whiteboard to integrate data files;
Step 7: said control program for said automated process transforms said completed data files into digital media files in WMV&WMA or MPEG4 format through compression program and transmit them to streaming server;
Step 8: said streaming server broadcasts lively programs with the received data files to said receiving terminals;
Step 9: said streaming server first integrates said broadcasted data files with a Script command program and Marker program at user end during live broadcasting and notes on synchronization requirement, then saves said files and automatically transforms said files into VOD (Video On Demand) digital files; and
Step 10: at receiving end, access to Internet is available for selecting files outputted from streaming server.

2. The live broadcasting method for SNG webeasting studio of claim 1, wherein in Step 9, said streaming server integrates said broadcasted files with commands and notes at user end during live broadcasting and automatically transforms said files into VOD digital files, said commands use Script program.

3. The live broadcasting method for SNG webcasting studio of claim 1, wherein in step 9, said audio/video server integrates said broadcasted files with commands and notes at user end during live broadcasting and automatically transforms the said into VOD digital files, said commands use Marker program.

4. A SNG webcasting studio system comprising:
a SNG special effect equipment to conduct mixing and special effect on image and voice, a Media Producer software to receive media files from SNG special effect equipment and automatically transform digitized media files into WMV&WMA digital media format through an automated process control program;
a synchronization control program for streaming audio/video, presentation files and digital whiteboard, comprising a PowerPoint Application, a digital whiteboard Application and computer monitor output interface, under a process of an automated process control program combining PPT, WORD, HTML or digital whiteboard to complete file integration; and
an streaming server, comprising a Web Server and a Media Server, receiving said synchronization control program from streaming audio/video, presentation files and digital whiteboard and providing online live broadcasting and VOD digital file saving and file management.

5. The SNG webcasting studio system of claim 4, wherein said webcasting encoder receives media data from SNG special effect equipment and transforms digitized media data into MPEG4 through an automated process control program.

6. The SNG webcasting studio system of claim 4, wherein said synchronization control program for streaming audio/video, presentation files and digital whiteboard is switchable between WORD/PPT application interfaces during real-time broadcasting and helps display hint.

7. The SNG webcasting studio system of claim 4, wherein VOD files of said synchronization control program for said streaming audio/video, presentation files and digital whiteboard are saved files for all data, on-site operation commands and notes during real-time broadcasting.

8. The SNG webcasting studio system of claim 4, wherein said SNG audio/video special effect equipment comprises:
an audio/video input device comprising an image input device and a voice input device;
a SNG special effect equipment comprising a video receiving mechanism, an audio receiving mechanism digital special effect and switch control, and receiving data from audio/video input device and integrating images and voices into digital media data; and an output device receiving said processed data from said SNG special effect equipment and transmitting said data through an output device to webcasting encoder or saving said files.

9. The SNG audio/video special effect equipment of claim 8, wherein said audio/video input device is composed of two sets of Composite terminals and two sets of S terminals.

10. The SNG audio/video special effect equipment of claim 8, wherein said audio input device is composed of three sets of voice input terminals (Source, AUX and MIC).

11. The SNG audio/video special effect equipment of claim 8, wherein said input device is IEEEE1394 specification device.

12. The SNG audio/video special effect equipment of claim 8, wherein said output device is AV terminal and media files are saved in videotapes.

13. The SNG audio/video special effect equipment of claim 8, wherein said output device is USB interface and said media files are output to save in computer.

14. The SNG audio/video special effect equipment of claim 8, wherein said output device is IEEE1394 device and said media files are output to save in computer.
